(19) United States
(12) Patent Application Publication
(10) Pub. No.: US 2022/0188465 A1
(43) Pub. Date: Jun. 16, 2022

(54) WIRELESS BOARD MANAGEMENT CONTROL SYSTEM

(71) Applicant: SoftIron Ltd., London (GB)

(72) Inventors: Phillip Edward Straw, Newark, CA (US); Stephen Hardwick, Austin, TX (US)

(21) Appl. No.: 17/542,246

(22) Filed: Dec. 3, 2021

Related U.S. Application Data
(60) Provisional application No. 63/125,823, filed on Dec. 15, 2020.

(51) Int. Cl. G06F 21/74; G06F 21/85; G06F 21/72

(52) U.S. Cl. CPC G06F 21/74; G06F 21/72; G06F 21/85

(57) ABSTRACT

A wireless management controller device is disclosed. In various embodiments, a board management controller device includes a wireless communication interface and a processor coupled to the wireless communication interface and configured to control the wireless communication interface independently of a main circuit board with which the management controller device is associated, and communicate via the wireless communication interface independently of the main circuit board with which the management controller device is associated.

### CROSS REFERENCE TO OTHER APPLICATIONS

This application claims priority to U.S. Provisional Patent Application No. 63/125,823 entitled WIRELESS BOARD MANAGEMENT CONTROL SYSTEM filed Dec. 15, 2020 which is incorporated herein by reference for all purposes.

### BACKGROUND OF THE INVENTION

A baseboard management controller (BMC) is a specialized service processor that monitors the physical state of a computer, network server or other hardware device using sensors and communicating with the system administrator through an independent connection. The BMC is part of the Intelligent Platform Management Interface (IPMI) and is usually contained in the motherboard or other main circuit board of the device to be monitored.

The BMC may be used to perform tasks that an administrator would otherwise need to physically visit the device, e.g., a server, to accomplish. Some of the more common use cases are power cycling a server and monitoring fan speeds/component temperatures, and hardware failures.

Typically, a system administrator communicates with a BMC via a physical, wired connection to the motherboard or other main circuit board on which the BMC is installed.

### BRIEF DESCRIPTION OF THE DRAWINGS

Various embodiments of the invention are disclosed in the following detailed description and the accompanying drawings.

FIG. 1 is a block diagram illustrating an embodiment of a baseboard management controller (BMC) with a wireless interface and associated system.

FIG. 2 is a block diagram illustrating an embodiment of a baseboard management controller with a wireless interface and environment.

FIG. 3A is a flow diagram illustrating an embodiment of a process to use wireless communication with a BMC to perform two-factor authentication.

FIG. 3B is a flow diagram illustrating an embodiment of a process to use wireless communication with a BMC to perform two-factor authentication.

FIG. 3C is a flow diagram illustrating an embodiment of a process to selectively provide access to BMC functionality via a wireless interface.

FIG. 3D is a flow diagram illustrating an embodiment of a process to use function-specific smart cards to access BMC functionality via a wireless interface.

FIG. 4A is a flow diagram illustrating an embodiment of a process to relay commands from a master BMC to a slave BMC via a wireless interface.

FIG. 4B is a flow diagram illustrating an embodiment of a process to aggregate data at a master BMC via a wireless interface.

FIG. 5A is a flow diagram illustrating an embodiment of a process to use a wireless interface of a BMC to establish communication with the BMC if a primary access technique fails.

FIG. 5B is a flow diagram illustrating an embodiment of a process to use a wireless interface of a BMC to lock down a system.

FIG. 5C is a flow diagram illustrating an embodiment of a process to use a wireless interface of a BMC to restore a system.

FIG. 6A is a flow diagram illustrating an embodiment of a process to adjust transmitted signal strength of a BMC wireless interface to limit wireless access to a secure zone.

FIG. 6B is a flow diagram illustrating an embodiment of a process to update data representing a network topology based on signal strength of a BMC wireless interface associated with one or more other systems.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A baseboard management controller (BMC) that includes a secure wireless communication interface is disclosed. In various embodiments, a BMC as disclosed herein includes a wireless communication interface that enables a system administrator or other authorized user to communicate with the BMC even if the motherboard or other main circuit board on which the BMC is installed cannot be used, or is not desired or trusted to be used, to communicate with the BMC.

In various embodiments, external communication to the BMC via its integrated wireless communication interface, without the use of a physical interface, gives convenient external access to the BMC functions. In some embodiments, this capability is used between wirelessly connected BMC devices, or to an external device, e.g. a mobile computing device, a contactless smart card or other near field communication device, and/or a remote node via a wireless WiFi connectivity to a wide area network (WAN). In some embodiments, the BMC has full functional control of its wireless communications interface, allowing wireless networks between BMCs or external devices to be realized. A hierarchy of BMC connectivity can be created by defining master and slave nodes within the wireless network.

In various embodiments, secure wireless connectivity is provided by BMC wireless interface control and existing functions. This localizes availability and enables secure communication between wireless nodes. Examples of wireless communications via which communication with a BMC as disclosed herein is performed, in various embodiments, include without limitation Wi-Fi, near field communications (NFC), Bluetooth, laser, and wireless (e.g., cellular, microwave, etc.) modem technologies.

In various embodiments, the BMC contains a cryptographically protected UUID (generated in manufacturing). By embedding the UUID in a contactless smart card or other wireless device, the smart card or other wireless device can be used for two factor identification when using existing management communications interfaces (USB/Ethernet). In some embodiments, the contactless smart card or other device is used to contact the BMC to authenticate the user prior to login. Other contactless cards can be used to access a specific function, in some embodiments, such as to allow booting, force reboot, or enter a test mode or other special operating mode. The BMC may have a mode where booting of the system in which the BMC is installed is prohibited without using the contactless smart card. For example, if a system is stolen, it cannot become operational without its associated contactless smart card.

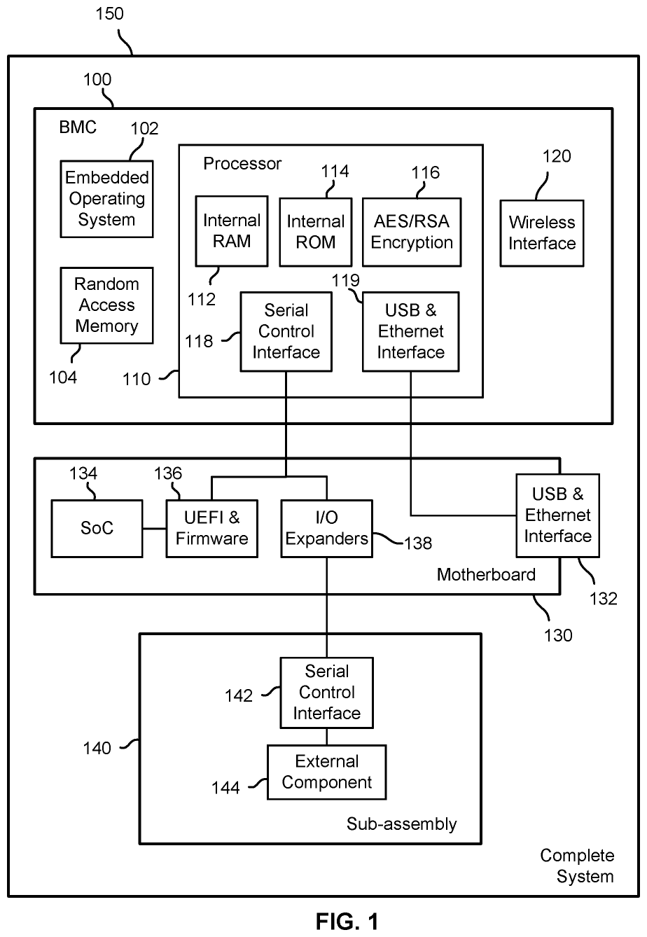

FIG. 1 is a block diagram illustrating an embodiment of a baseboard management controller (BMC) with a wireless interface and associated system. In the example shown, BMC 100 includes an embedded operating system 102, random access memory 104, and processor 110. In various embodiments, processor 110 comprises a System on a Chip (SoC) that includes internal RAM 112, internal ROM 114, AES/RSA encryption module 116, serial control interface 118, and USB & Ethernet interface 119. BMC 100 further includes wireless interface component 120. In various embodiments, processor 110 is connected to wireless interface component 120 and has full control of the wireless of wireless interface component 120.

In various embodiments, BMC 100 may comprise an integrated circuit and/or one or more components on a dedicated printed circuit board. In some embodiments, BMC 100 comprises a dedicated printed circuit board having a knife edge or other connector by which it is physically and removably installed on the motherboard 130. In various embodiments, any permanent or non-permanent structures to connect the BMC 100 to the motherboard 130 may be used.

While in the example shown in FIG. 1 the main circuit board with which the BMC 100 is associated and configured to manage is a “motherboard”, in various embodiments a BMC having a wireless interface, as disclosed herein, may be used to manage any main board or boards and/or associated components (e.g., subassemblies).

In various embodiments, the embedded operating system 102 contains a Universally Unique Identifier (UUID) generated at time of manufacture. In some embodiments, the UUID is received using cryptographic methods. The UUID is used to perform management functions, such as to receive a UUID via wireless interface 120, e.g., from a smart card or other device, compare the received UUID to the UUID stored by embedded operating system 102, and allowing access, performing an operation, etc. based on a determination that the UUID received via the wireless interface 120 matches the UUID stored by embedded operating system 102.

Referring further to FIG. 1, using the Serial Control Interface 118, the processor 110 can interact with other components comprising the complete system 150. The Serial Control Interface 118 can logically connect to both the Motherboard 130 and Sub-assemblies 140. The Motherboard 130 contains a System on a Chip (SoC) 134 that provides overall control of the complete system 150, in the example shown. UEFI and Firmware 136 are used by the SoC 134 to accomplish this task. Via the Serial Control Interface 118, the BMC 100 can influence the function of the SoC 134 by accessing the UEFI and Firmware 136, in various embodiments. The actions performed by the BMC in this manner may be commanded and/or controlled via communications sent via wireless interface 120. In various embodiments, these actions can be performed on the UEFI and Firmware 136 even if the SoC 134 on the Motherboard 130 is not powered.

In the example shown, the Motherboard 130 also contains an I/O Expander 138, which splits the Serial Control Interface into sub channels. These are connected to a corresponding Serial Control Interfaces 142 on the Sub-assemblies 140. This allows the BMC 100 to query or control any External Components 144 on the Sub-assembly 140, such as hard drive, network interface cards (NIC), or other components. This can include determining the operating status of these components, such as detecting the failure of a physical interface, or influence their operation, e.g., disable them. In various embodiments, these actions can be performed even if the SoC 134 on the Motherboard 130 is not powered.

The Processor 110 contains an AES/RSA Encryption Module 116. In various embodiments, AES/RSA Encryption Module 116 is used to cryptographically protect stored information or secure communications channels.

The USB and Ethernet Interface 119 of processor 110 is connected, in this example to a corresponding USB and Ethernet Interface 132 of the motherboard 130, providing access to BMC 100 via USB or Ethernet physical connectors of the motherboard 130, for example. In some embodiments, wireless interface 120 of BMC 100 may be used as a secondary (e.g., for a second factor of authentication) and/or backup (e.g., in the event of failure or compromise of motherboard 130) channel to communicate with and control operation of BMC 100.

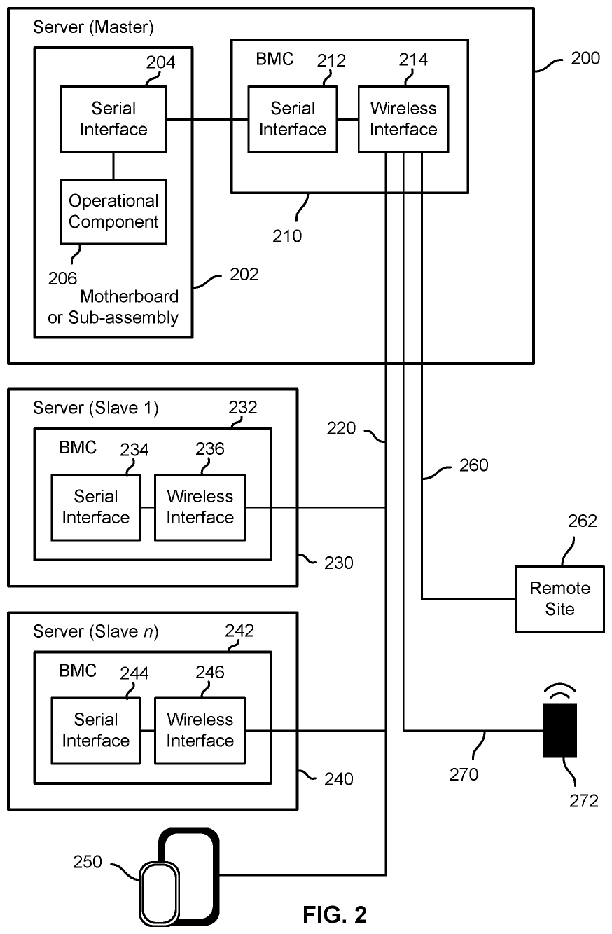

FIG. 2 is a block diagram illustrating an embodiment of a baseboard management controller with a wireless interface and environment. In the example shown, master server 200 includes a motherboard 202 configured to provide connectivity via serial interface 204 to an operational component 206. In this example, motherboard 202 communicates via serial interface 204 with BMC 210 via its serial interface 212. BMC 210 further includes wireless interface 214. In various embodiments, wireless communications received via wireless interface 214 are used to perform BMC management functions with respect to motherboard 202 and its operational component 206.

In the example shown, master server 200 is connected via a local area network (LAN) 220 to “slave” (or peer) servers 1 through n, represented in FIG. 2 by servers 230 and 240. The servers 230 and 240 are connected to LAN 220 wirelessly, each through a corresponding wireless interface 236, 246 of its BMC 232, 234. The wireless interfaces 236, 246 are in turn connected via serial interfaces 234, 244, which provide connectivity to the respective motherboards and associated operational component(s), subassemblies, etc. of the servers 230, 240 (which are not shown in FIG. 2). In addition, in this example mobile devices 250 are connected wirelessly to LAN 220, enabling such devices to be used to communicate to one or more of the BMCs 210, 232, 242 via secure wireless communications using cryptographic methods. Mobile devices can include end user devices, e.g., tablet/phone or wireless storage devices.

In addition, access to BMC management functionality of BMC 210, and via BMC 210 to the respective BMCs 232, 242 of servers 230, 240, is provided to a system administrator at remote site 262 via a secure wireless communications sent, using cryptographic methods, via a Wide Area Network (WAN) 260 to which BMC 210 is connected via wireless interface 214.

In this example, a smart card (or other contactless near field communication device) 272 is connected via near field communication (NFC) network or connection 270 to BMC 210 via secure wireless communications sent, using cryptographic methods, via wireless interface 214.

The NFC network 270 can be used to communicate via secure wireless communications using cryptographic methods with smart devices 272, such as a smart card. The smart card can be programmed with the UUID of a specific server. Once the specified UUID has been recognized by a BMC 210, 232, 242 as being associated with the server on which that BMC is installed, then additional instructions can be processed by the Embedded Operating system of the BMC (see FIG. 1). This can include one or more of the following, in various embodiments:
1. Allow external communication via the USB or Ethernet Interfaces (e.g., interfaces 132 of FIG. 1)
2. Allow specific modification of the UEFI and Firmware (e.g., UEFI and Firmware 136 of FIG. 1)
3. Enable/Disable the SoC (e.g., SoC 134 of FIG. 1) and/or control of the complete system (e.g., complete system 150 of FIG. 1)
4. Modify the operation of Sub-assemblies (e.g., sub-assembly 140 of FIG. 1)

In various embodiments, the wireless interfaces 214, 236, 246 can utilize a wide range of standard communications protocols. In some embodiments, for example, the WAN 260 may use technologies such as cellular communication, line of site microwave, etc. The LAN 220 can use technologies such as Wi-Fi, Bluetooth, etc. The near field communication network or connection 270 can use technologies such as Near Field Communications (NFC).

In some embodiments, the NFC network or connection 270 will only operate in close proximity, e.g., 10-20 cm, of the wireless interface 214. Although only shown on the master server 200, in this example, in various embodiments near field communications 270 can be used to communicate with any server, such as via wireless interface 236 of BMC 232 of server 230 or via wireless interface 246 of BMC 242 of server 240. In some embodiments, WAN 260 similarly may include BMCs 232 and 242 of servers 230 and 240, respectively.

Once secure communications have been established between and endpoint and a BMC via its wireless interface, as disclosed herein, the endpoint can send commands to the BMC and receive information from it. This allows the endpoint to (remotely) execute any BMC function, including those used to control the motherboard or sub-assemblies, with or without the motherboard SoC being powered.

In various embodiments, the BMC 210 of the master server 200 may be used to route communications between a remote site, such as remote site 262, and other servers 230, 240 using the LAN 220. In this manner, a remote site such as remote site 262 can communicate with a cluster of servers by commanding a master BMC associated with a master server to relay communications to/from the respective BMCs on other servers in the cluster, all through out-of-band communications sent via the respective wireless interfaces of the respective BMCs.

Since the wireless communication interfaces (220, 260, 270) are independent of the system on which the BMC is installed, they can be used to communicate with the BMC and motherboard when all other physical communications interfaces have failed, independent of the operational status of the operational component 206, e.g., a “bricked” or powered down (ACPI S4/S5) server.

In various embodiments, operations described herein as being performed by a BMC via wireless communication via a secure wireless interface of the BMC can be performed regardless of whether the motherboard and/or motherboard SoC is in an operational state, e.g., ACPI S4/S5.

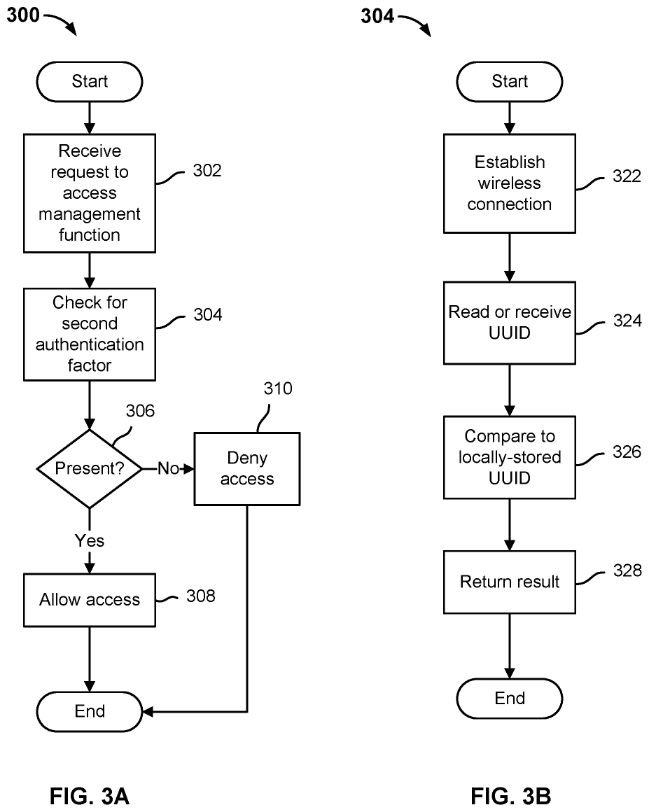

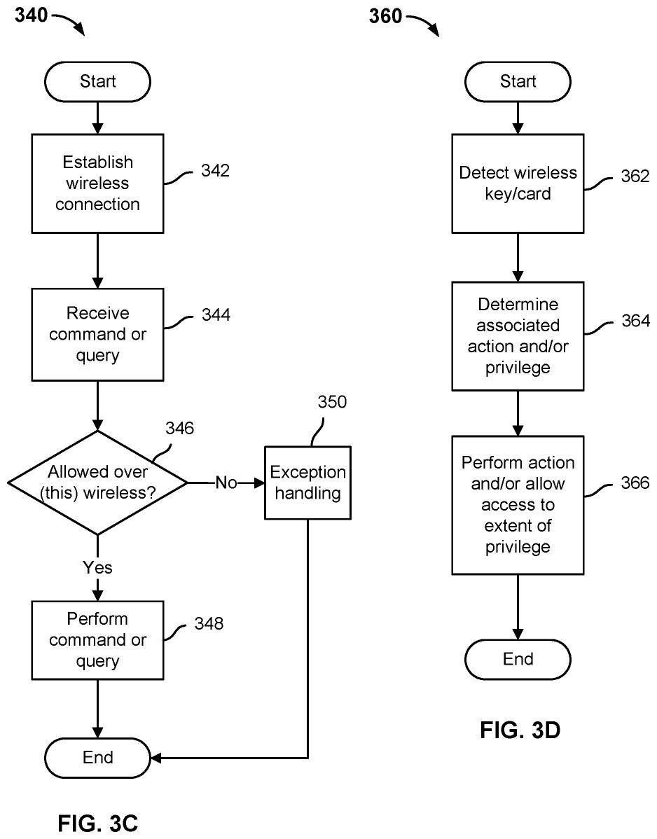

FIG. 3A is a flow diagram illustrating an embodiment of a process to use wireless communication with a BMC to perform two-factor authentication. In various embodiments, the process 300 of FIG. 3A is performed by a wireless-capable BMC as disclosed herein, such as BMC 100 of FIG. 1 or BMC 210 of FIG. 2. In the example shown, at 302 a request is received via an interface of a BMC, e.g., e.g., USB and Ethernet interface 119 of BMC 100 of FIG. 1, to perform a management function. For example, a system administrator may send an Intelligent Platform Management Interface (IPMI) command or communication to the BMC. The command may be provided via a network or USB port and/or interface of a motherboard on which the BMC is installed, such as USB and Ethernet interface 132 of motherboard 130 in the example shown in FIG. 1.

At 304, the BMC checks to determine whether a required second factor of authentication has been received via a wireless interface of the BMC, e.g., wireless interface 120 of BMC 100. For example, a second factor of authentication may be requested and/or provided via one or more of a mobile device connected to the wireless interface of the BMC via a local area network (LAN), a remote site connected to the wireless interface of the BMC via a wide area network (WAN), or a smart card or other near field communication device in close proximity to the wireless interface of the BMC, such as devices 250, remote site 262, and/or smart card 272, in the example shown in FIG. 2.

At 306, if the required second authentication factor is determined to have been received and valid, access is allowed at 308. For example, a command received at 302 may be executed. If the second authentication factor is not received or is received but determined not to be valid (306), access is denied (310).

FIG. 3B is a flow diagram illustrating an embodiment of a process to use wireless communication with a BMC to perform two-factor authentication. In various embodiments, the process FIG. 3B implements step 304 of the process 300 of FIG. 3A. In various embodiments, the process 304 of FIG. 3B is performed by a wireless-capable BMC as disclosed herein, such as BMC 100 of FIG. 1 or BMC 210 of FIG. 2. In the example shown, at 322 a wireless connection is established, if not already present. At 324, a UUID is received and/or read from data received via the wireless connection. At 326, the received UUID is compared to a locally-stored UUID of the BMC. For example, the UUID may be stored locally in internal ROM of the BMC, such as ROM 114 of FIG. 1. The locally-stored UUID may be stored in encrypted form and may be read and decrypted, e.g., by an encryption module of the BMC, such as AES/RSA encryption module 116 of FIG. 1. At 328, a result of the comparison (match=success, not matched=fail) is returned, e.g., to a thread or entity performing the process 300 of FIG. 3A.

FIG. 3C is a flow diagram illustrating an embodiment of a process to selectively provide access to BMC functionality via a wireless interface. In various embodiments, the process 340 of FIG. 3C is performed by a wireless-capable BMC as disclosed herein, such as BMC 100 of FIG. 1 or BMC 210 of FIG. 2. In the example shown, at 342 a wireless connection to the BMC is established. At 344, a command or query is received via the wireless connection. At 346, the BMC determines whether the wireless command is permitted to be requested via the wireless connection established at 342. For example, in some embodiments, a system administrator may configure one or more policies indicating which types of command or actions are permitted to be performed via the wireless interface of the BMC. In some embodiments, permissions may vary based on the user and/or role. For example, the connection established at 342 may be associated with a particular user, based for example on an identifier or attribute of a device the user is using to communicate wirelessly with the BMC. A device attribute could include the Received Signal Strength Indicator, or RSSI, as this can be linked to the proximity of the device. The user and/or device identity may be mapped to a set of access privileges, which are used at 346 to determine whether a command received at 344 is permitted. In another example, access to privileges may depend on other context data, such as time of date, security posture of the system, etc. In yet another example, access may be determined based at least in part on the presence (or not) of a smart card or other near field communication-enabled device or item. In such an approach, a super-user may control access to cards required to perform specific tasks. To authorize a task, the super-user would provide the card associated with and specific to a task or set of tasks to another administrative user the super-user wishes to authorize and/or allow to perform a task with which the card is associated.

If the command or query received at 344 is determined at 346 to be allowed, at 348 the command or query is performed. If not, at 350 the request is denied and an error message is returned.

FIG. 3D is a flow diagram illustrating an embodiment of a process to use function-specific smart cards to access BMC functionality via a wireless interface. In various embodiments, the process 360 of FIG. 3D is performed by a wireless-capable BMC as disclosed herein, such as BMC 100 of FIG. 1 or BMC 210 of FIG. 2. In the example shown, at 362 the BMC detects, via its wireless interface, the presence of a “smart” contactless key or card. At 364, data encoded in a signal received from the key or car is mapped to an associated action and/or privilege. For example, the signal may include a code or other identifier that maps directly to a specific action to be taken by the BMC, such as to lock down, shut down, reboot, and/or reflash (e.g., install or reinstall firmware to) the BMC. At 366, the BMC performs the action and/or provides access to the extent of a privilege level determined at 364.

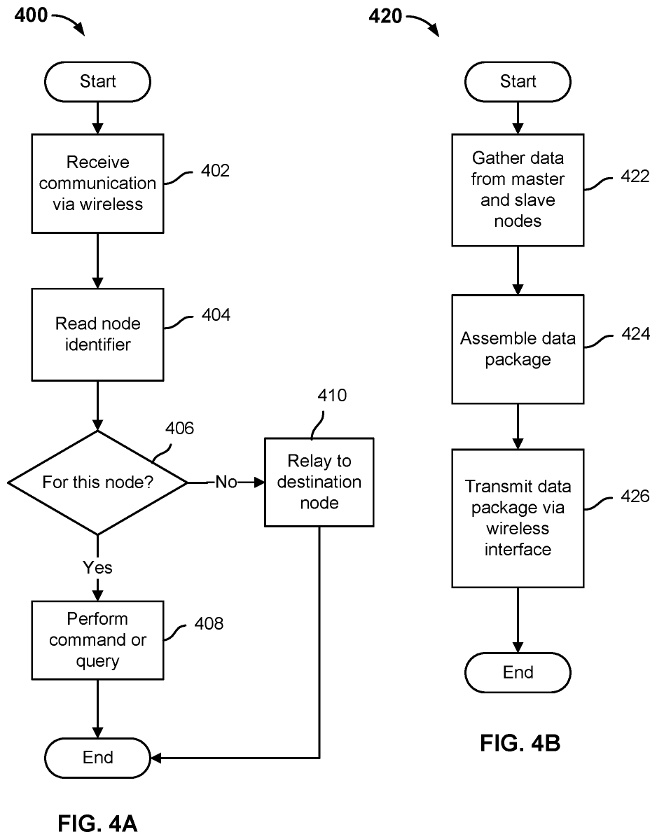

FIG. 4A is a flow diagram illustrating an embodiment of a process to relay commands from a master BMC to a slave BMC via a wireless interface. In various embodiments, the process 400 of FIG. 4A is performed by a wireless-capable BMC as disclosed herein, such as BMC 210 of FIG. 2. In various embodiments, the process 400 of FIG. 4 may be used to manage a cluster of systems, such as a server cluster, each provided with a wireless-capable BMC. The BMCs may be connected together in a wireless local area network (LAN) using cryptographic communication methods, such as LAN 220 of FIG. 2. One server, the master server, may be used to relay communications to and from the other BMCs, providing out-of-band connectivity to all systems on the LAN, without reliance on access to or control of the systems (e.g., servers) on which the respective BMCs are installed.

In the example shown in FIG. 4A, at 402 a BMC on a master server or other system receives a communication via its wireless interface. At 404, a destination node of the communication is determined. For example, a UUID of a BMC for which the communication is intended may be extracted from the communication received at 402 and mapped to a known slave BMC in the cluster. If the communication is directed to the local node (406) an associated command or query is performed locally (408). If the communication is meant for another system in the cluster (406), the communication is sent to the intended destination via the BMC-to-BMC wireless LAN (410).

FIG. 4B is a flow diagram illustrating an embodiment of a process to aggregate data at a master BMC via a wireless interface. In various embodiments, the process 420 of FIG. 4B is performed by a wireless-capable BMC as disclosed herein, such as BMC 210 of FIG. 2. The process 420 may be used, for example, to gather statistics or other data from slave systems at a master system and report them to a remote site. In the example shown in FIG. 4B, at 422 data is gathered by a master BMC from slave BMCs associated with other systems in the cluster. At 424, a data package comprising all or part of the received data is assembled and at 426 the data package is transmitted, e.g., via aWAN, to a remote site or other configured destination.

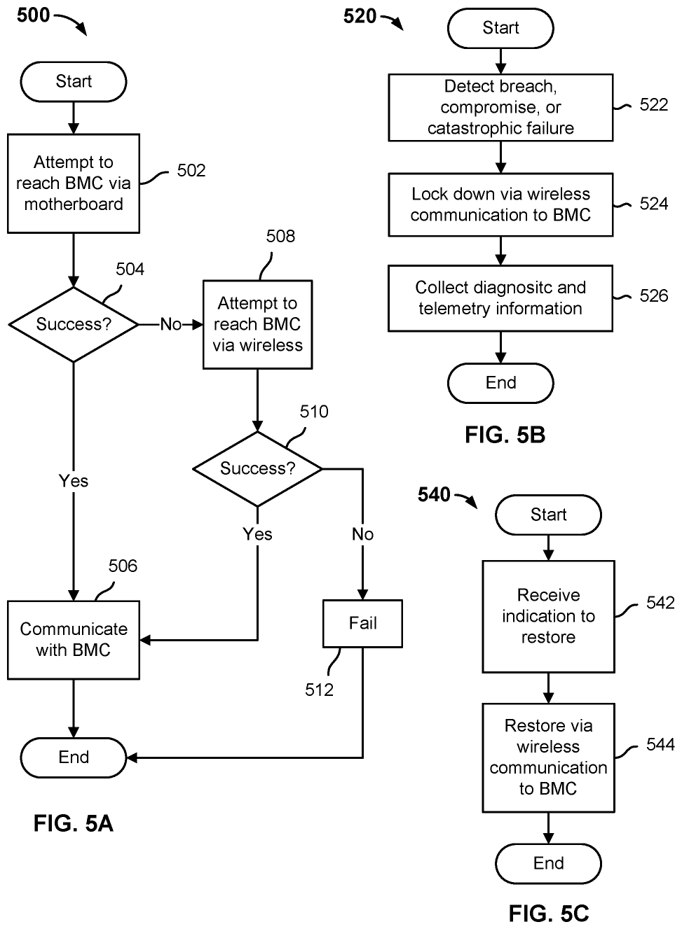

FIG. 5A is a flow diagram illustrating an embodiment of a process to use a wireless interface of a BMC to establish communication with the BMC if a primary access technique fails. In various embodiments, the process 500 of FIG. 5A is performed by a wireless-capable BMC as disclosed herein, such as BMC 100 of FIG. 1 or BMC 210 of FIG. 2. In the example shown, at 502, a communication is sent to the BMC via a motherboard or other main board on which the BMC is installed. For example, an IPMI or other communication may be sent to the BMC 100 of FIG. 1 via the USB and Ethernet interface 132 of motherboard 130 and USB and Ethernet interface 119 of BMC 100. In communications is established successfully (504), the communication provides in the conventional manner (506). If the BMC cannot be reached in the conventional manner (502, 504), at 508 communication is attempted to be established via the wireless interface of the BMC. If communication is established via the wireless interface (510), then communication proceeds via that interface (506). If communication cannot be established via the wireless interface of the BMC (510), the attempted communication fails (512).

FIG. 5B is a flow diagram illustrating an embodiment of a process to use a wireless interface of a BMC to lock down a system. In various embodiments, the process 520 of FIG. 5B is performed by a wireless-capable BMC as disclosed herein, such as BMC 100 of FIG. 1 or BMC 210 of FIG. 2. In the example shown, at 522, a breach, compromise, degradation, or unrecoverable failure of the system the BMC manages, and/or a sub-assembly thereof, is detected. The circumstances may be such that the interface(s) of the system managed by the BMC may not be available and/or may not be trusted to be used to send and receive management commands. At 524, a communication is sent to the BMC via its wireless interface, bypassing the system and/or components managed by the BMC, to lockdown the system or take other remedial action. For example, the BMC may be commanded, via a communication received via its wireless interface, to selectively disable communication interfaces of the system the BMC manages and/or a sub-assembly thereof, or to force the system and/or a sub-assembly thereof to shut down, such as by disabling a power supply of the motherboard or other main board and/or of a sub-assembly. In this way, further compromise or harm may be prevented while system administrators respond to and resolve the issue. At 526, diagnostic and telemetry information are collected without powering the motherboard or other main board and/or of a sub-assembly. In some embodiments, the retrieved data can be used to determine a mitigation strategy.

FIG. 5C is a flow diagram illustrating an embodiment of a process to use a wireless interface of a BMC to restore a system. In various embodiments, the process 540 of FIG. 5C is performed by a wireless-capable BMC as disclosed herein, such as BMC 100 of FIG. 1 or BMC 210 of FIG. 2. In the example shown, at 542, an indication is received to restore a system and/or sub-assembly of a system managed by a wireless-capable BMC. At 544, the system and/or sub-assembly are restored to operation at least in part through authenticated and secure communications sent using cryptographic methods via a wireless interface of the BMC. Examples of actions that may be taken, in various embodiments, to restore a system or sub-assembly through communications sent via a wireless interface of the BMC include, without limitation, re-flashing (e.g., installing or reinstalling firmware), rebooting, restoring power in a selective and defined manner, selectively restoring and/or reconfiguring communications interfaces, and reprogramming one or more components. In various embodiments, communications to perform the above actions may be sent by one or more of a wireless device via a LAN connection via the wireless interface of the BMC, a remote site connected by a WAN to the BMC via a wireless interface of the BMC, and a smart card or other contactless NFC device in close proximity to the wireless interface of the BMC.

In various embodiments, the information required to restore a system or sub-assembly may come from an external storage source that is locally available. These devices may connect to the BMC via a secure, authenticated wireless connection using cryptographic methods. The BMC can configure the external storage source to provide a boot location for the motherboard SoC 134 in FIG. 1. In one embodiment this external storage device could be a dedicated wireless hard drive. The BMC can facilitate a secure, authenticated wireless connection using cryptographic methods between the wireless hard drive and the motherboard SoC. In another embodiment, the external storage source could be a second BMC in a local storage server. The local, master BMC 210 in FIG. 2 can connect to a slave BMC 232 or 242 in FIG. 2 of the remote storage server. The master BMC can then use the remote storage server as an external storage source to provide a boot location for the motherboard SoC 134 in FIG. 1.

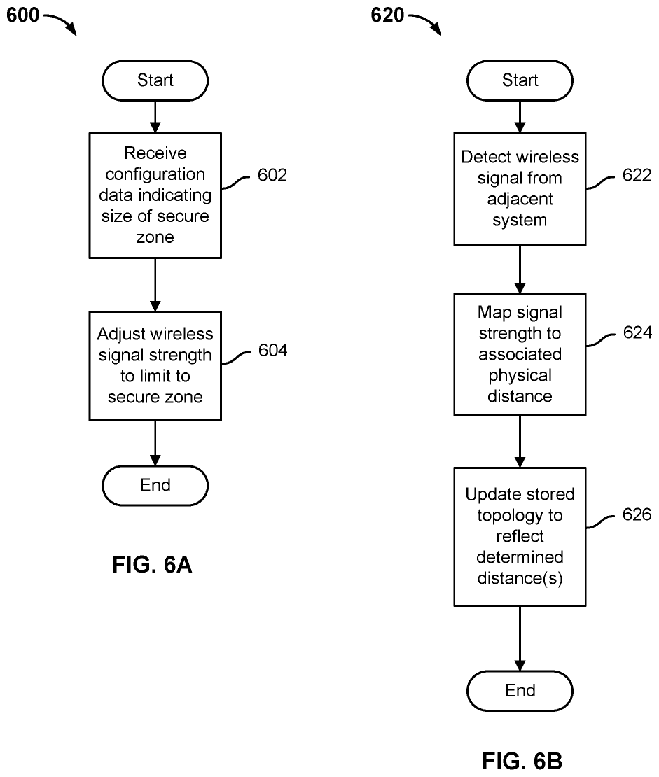

FIG. 6A is a flow diagram illustrating an embodiment of a process to adjust transmitted signal strength of a BMC wireless interface to limit wireless access to a secure zone. In various embodiments, the process 600 of FIG. 6A is performed by a wireless-capable BMC as disclosed herein, such as BMC 210 of FIG. 2. In the example shown, at 602, configuration data is received indicating a size (e.g., radius or other distance, dimensions, etc.) of a secure zone associated with a system managed by the BMC. At 604, a signal strength of a wireless interface of the BMC is adjusted to attempt to limit availability to connect or attempt to connect via the wireless interface of the BMC to devices (e.g., wireless computing devices, smart cards or keys, etc.) present within the secure zone. For example, a BMC may perform a lookup to determine for a given configured secure range or distance a corresponding power level at which to transmit via its wireless interface. In various embodiments, the process 600 of FIG. 6A reduces the opportunity for a malicious actor to attempt gain access to the management functions of the BMC by connecting to the BMC via the wireless interface of the BMC, since physical access to a secure room or building may be required to get within range to attempt to connect to the wireless interface of the BMC.

FIG. 6B is a flow diagram illustrating an embodiment of a process to update data representing a network topology based on signal strength of a BMC wireless interface associated with one or more other systems. In various embodiments, the process 620 of FIG. 6B is performed by a wireless-capable BMC as disclosed herein, such as BMC 210 of FIG. 2. In the example shown, at 622, the BMC detects a wireless signal associated with a peer or slave BMC on another system. For example, the BMC may receive the signal via a wireless interface of the BMC and may extract an identifier of the other BMC (or other system or device). At 624, the BMC measures the signal strength of the received signal strength indicator, or RSSI, and maps the signal strength to an associated estimated physical distance to the other system. For example, the BMC may perform a lookup based on the identity of the sender of the received signal and the signal strength of the received signal to determine an estimated physical distance to the sender.

At 626, the BMC updates stored topology information to reflect the estimated distance determined at 624. For example, the BMC may update a table listing for each of one or more systems a corresponding estimated distance to that system.

In some embodiments, the process 620 of FIG. 6B may be performed by multiple BMCs in a cluster. Slave server BMCs may report their distance estimates to a master BMC, which at 626 may use the readings by its slave servers and its own readings to generate a map of where the respective servers are located relative to each other. For example, if a master server A estimates server B is 5 feet away and each of servers C and D is about 7 feet away, server B estimates each of A, C, and D is about 5 feet away, and C and D each estimates the other is 10 feet away, the BMC at master server A (or other BMCs in the cluster) may conclude that servers A, C, and D are arranged around server B on a circle having an approximately 5 feet radius from B, with C and D position on either side of server B along a line perpendicular to the line between A and B.

In various embodiments, techniques disclosed herein may be used to perform management functions using a BMC, through communications sent via a wireless interface of the BMC, even in circumstances in which the BMC cannot or is not desired or trusted to be reached via a system the BMC is installed and configured to manage, such as a motherboard or other main board on which the BMC is installed. A BMC having a wireless interface, as disclosed herein, enables further functionality and utility, as disclosed herein.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A management controller device, comprising:
a wireless communication interface; and
a processor coupled to the wireless communication interface and configured to:
control the wireless communication interface independently of a main circuit board with which the management controller device is associated; and
communicate via the wireless communication interface independently of the main circuit board with which the management controller device is associated.

2. The device of claim 1, wherein the processor is further configured to control the main circuit board.

3. The device of claim 2, wherein the processor is configured to control the main circuit board when the main circuit board is in a powered down or other state of non-operation.

4. The device of claim 2, further comprising a serial control interface coupled to the processor and wherein the processor is configured to control the main circuit board at least in is part via communications sent via the serial control interface.

5. The device of claim 4, wherein the processor is further configured to configure and use an input/output expander of the main circuit board to communicate with and control one or more sub-assemblies associated with the main circuit board.

6. The device of claim 1, further comprising one or both of a USB interface and an Ethernet interface coupled to the processor.

7. The device of claim 6, wherein the processor is configured to communicate via one or both of the USB interface and the Ethernet interface via a connection to a corresponding interface of the main circuit board.

8. The device of claim 7, wherein the corresponding interface of the main circuit board includes a physical port configured to receive a connector associated with a physical connection to the corresponding interface.

9. The device of claim 1, wherein the processor is further configured to use the wireless communication interface to establish a local area network (LAN) connection to one or more other management controller devices, each associated with a corresponding other main circuit board.

10. The device of claim 1, wherein the processor is further configured to use the wireless communication interface to establish a wide area network (WAN) connection to a remote site.

11. The device of claim 1, further comprising an encryption module and wherein the processor is configured to control and use the encryption module independently of the main circuit board with which the management controller device is associated.

12. The device of claim 11, wherein the processor is configured to use the encryption module to communicate securely via the wireless communication interface.

13. The device of claim 11, wherein the processor is configured to use the encryption module to authenticate requests received via the wireless communication interface.

14. The device of claim 1, wherein the processor is configured to receive via the wireless communication interface a request to perform a management function with respect to the main circuit board with which the management controller device is associated.

15. The device of claim 14, wherein the processor is configured to extract an identifier from the request and compare the extracted identifier to a locally-stored identifier of the management controller device; and to perform the request based at least in part on a determination that the extracted identifier matches the locally-stored identifier.

16. The device of claim 1, wherein the processor is configured to receive via a communication interface other than the wireless communication interface a request to perform a management function with respect to the main circuit board; receive via the wireless communication interface a second factor of authentication associated with the request; and to perform the request based at least in part on a determination that the second factor of authentication is valid.

17. The device of claim 1, the processor is configured to receive via the wireless communication interface a request to perform a management function with respect to the main circuit board with which the management controller device is associated; and to perform the management function based at least in part on a determination that the management function is authorized to be performed based on the request as received via the wireless communication interface.

18. The device of claim 1, wherein the processor is further configured to use the wireless communication interface to establish a local area network (LAN) connection to one or more other management controller devices, each associated with a corresponding other main circuit board; receive a communication via the wireless interface; determine the communication is associated with a determined one of the one or more other management controller devices; and relay the communication via the LAN to the determined one of the one or more other management controller devices.

19. The device of claim 18, wherein the processor is further configured to receive via the LAN from a reporting one of said one or more other management controller devices a report of data associated with the corresponding main circuit board associated with the reporting management controller device; and relay at least part of the report of data to a remote destination node.

20. The device of claim 1, wherein the processor is configured to receive via the wireless communication interface a command to lock down all or part of the main circuit board; and to lock down the main circuit board to an extent indicated by the command.

21. The device of claim 20, wherein the processor is configured to lock down the main circuit board by selectively shutting down any communication interface of the main circuit board and a power supply associated with the main circuit board or a sub-assembly associated with the main circuit board.

22. The device of claim 1, wherein the processor is configured to receive via the wireless communication interface a command to restore the main circuit board after a failure or compromise of the main circuit board.

23. The device of claim 22, wherein the processor is configured to restore the main circuit board, irrespective of its current operating condition, by performing one or more of the following: re-flashing, writing or rewriting firmware of the main circuit board, restoring a communication interface of the main circuit board, reactivating a power supply of the main circuit board, reprogramming the main circuit board or a component or sub-assembly of the main circuit board, and rebooting the main circuit board.

24. The device of claim 1, wherein the processor is further configured to use the wireless communication interface to establish a local area network (LAN) connection to one or more other management controller devices, each associated with a corresponding other main circuit board; measure the respective signal strengths of signals received from each of said one or more other management controller devices; and determine at least aspects of a physical arrangement of systems associated with the other main circuit boards relative to a system associated with the main circuit board with which the management controller device is associated based at least in part on the signal strength measurements.

25. The device of claim 1, wherein the processor is configured to receive a configuration data indicating a secure distance; map the secure distance to a corresponding signal strength of the wireless communication interface; and configure the wireless communication interface to broadcast at a level associated with said corresponding signal strength of the wireless is communication interface.

26. The device of claim 1, wherein the processor is configured to receive a communication via the wireless communication interface; extract from the communication data associated with a command; map the data associated with a command to a corresponding action to be performed by the management controller device; and perform the action with respect to the main circuit board.

27. A method, comprising:
controlling a wireless communication interface of a management controller device independently of a main circuit board with which the management controller device is associated; and
communicating via the wireless communication interface independently of the main circuit board with which the management controller device is associated.

28. The method of claim 27, wherein the management controller device is configured to control the main circuit board when the main circuit board is in a powered down or other state of non-operation.

29. A computer program product embodied in a non-transitory computer readable medium and comprising computer instructions for:
controlling a wireless communication interface of a management controller device independently of a main circuit board with which the management controller device is associated; and
communicating via the wireless communication interface independently of the main circuit board with which the management controller device is associated.
